(19) United States
(12) Patent Application Publication
(10) Pub. No.: US 2026/0075637 A1
(43) Pub. Date: Mar. 12, 2026

(54) WIRELESS COMMUNICATION METHOD AND APPARATUS THEREFOR

(71) Applicant: ESPRESSIF SYSTEMS (SHANGHAI) CO., LTD., Shanghai (CN)

(72) Inventors: Yuanyuan ZHANG, Shanghai (CN); Shengdong GU, Shanghai (CN); Junyi ZHANG, Shanghai (CN)

(21) Appl. No.: 19/107,822

(22) PCT Filed: Aug. 29, 2023
(86) PCT No.: PCT/CN2023/115531

§ 371 Date: Feb. 28, 2025

(30) Foreign Application Priority Data
Aug. 29, 2022 (CN) 202211041850.7

(51) Int. Cl. H04W 72/563; H04W 12/06; H04W 48/20

(52) U.S. Cl. CPC H04W 72/563; H04W 12/06; H04W 48/20

(57) ABSTRACT

Disclosed is a wireless communication method including: acquiring coexistence request priorities of a plurality of communication services of each of a plurality of wireless communication modules; grouping the plurality of wireless communication modules according to a circuit resource contention relationship; sequentially sorting the coexistence request priorities of the wireless communication modules in each group to select a wireless communication module having the highest coexistence request priority; and to select a wireless communication module having the highest coexistence request priority; sorting the highest coexistence request priorities of the groups to designate the group with a maximum value of the highest coexistence request priority as a priority group; allocating a coexistence grant signal to the wireless communication module having a highest intra-group transmission priority; and allocating, for each of remaining groups, a coexistence grant signal to a wireless communication module having a highest intra-group reception priority in the group.

### TECHNICAL FIELD

Embodiments of the present disclosure generally relate to the field of wireless communication, and more specifically, to a wireless communication method and apparatus therefor for reducing coexistence interference of wireless communication protocols.

### BACKGROUND

With the development of wireless communication technology and the diverse demands of various Internet of Things (IoT) applications for wireless communication, more and more terminal devices have integrated various wireless communication functions such as Wi-Fi, Bluetooth (BT), Bluetooth Low Energy (BLE) and ZigBee. The various wireless communication functions in a multi-mode wireless communication terminal can be implemented by a single chip or module supporting multi-mode communication, or by a combination of multiple single-mode communication chips or modules.

In a terminal that supports multiple wireless communication modes, these wireless communication modules compete for circuit resources or channel resources, such as operating frequency bands of Wi-Fi and BT overlapped at 2.4 GHz; and multiple communication modules may share a same RF transceiver circuit. How to efficiently achieve coexistence of multiple wireless communication protocols or modules and to reduce mutual interference among the wireless communication protocols has become a key technology to support a multi-mode wireless communication terminal.

Currently, a common solution to address the problem in the coexistence of multiple wireless communication modes is to optimize an antenna design of each communication module in the device. Specifically, Chinese invention patent publication No. CN110858981A discloses a method for reducing coexistence interference of Wi-Fi and BLE by adjusting the antenna design of the Wi-Fi and the BLE on a PCB board. However, the coexistence method that relies on modifying the antenna design of each communication module can only reduce interference among independent communication modules, but cannot solve the channel interference among multi-mode communication modes in a single chip, nor can it solve the contention for radio frequency circuit resources among multiple communication protocols or modules. Moreover, the method of optimizing antenna design has high requirements on the size and appearance of terminal devices, making it difficult to implement in actual products.

Another solution is to perform frequency domain avoidance among different communication modes. Chinese invention patent No. CN104902545 proposes a frequency domain avoidance method, which fully utilizes the characteristics of frequency-hopping communication in BT and Zigbee. By avoiding the frequency hopping points of each of Zigbee and BT from the operating Wi-Fi channels, this method minimizes mutual interference between the spectrum of Zigbee or BT and that of Wi-Fi, thereby enabling the simultaneous operation of multiple wireless communication modules. In theory, frequency domain avoidance among different wireless communication protocols is an optimal solution for reducing coexistence interference among wireless communication protocols. However, it can only address the contention for channel resources among some frequency-hopping wireless communication protocols (such as Zigbee and BLE). This method still cannot solve the contention for RF circuit resources in the multi-mode communication in a single chip, nor can it solve channel conflict between other non-frequency hopping modules, thus its application scenarios are limited.

In addition, another solution is to use time domain avoidance through time-division communication among different communications. Time domain avoidance refers to the operation of multiple wireless communication modules through time-division multiplexing under the scheduling of a coexistence algorithm, thereby solving the resource-sharing problem among multiple wireless communication modules. Compared with the above two solutions, the time domain avoidance method through time-division communication is currently the most widely used and most widely applicable wireless communication coexistence solution. Specific implementation schemes can be found in U.S. Pat. No. 10,667,285B2, Chinese invention Patent No. CN109392177, and Chinese invention Patent No. CN106850723, etc.

Regarding the time domain avoidance method through time-division communication, Chinese invention patent publication No. CN108934046A proposes reserving transmission time for ZigBee within the Wi-Fi Beacon period. During the ZigBee time slot, Wi-Fi will cease transmission and reception, thereby avoiding mutual interference and resource contention between Wi-Fi and ZigBee. This solution has a large time-switching granularity and lacks real-time performance and flexibility. It only considers the Wi-Fi Beacon period and Zigbee's guaranteed time slot (GTS), making it suitable for only a limited range of business scenarios and unable to support other Wi-Fi processes or other communication protocols.

U.S. Pat. No. 10,667,285B2 proposes a coexistence scheme for Zigbee, Thread, BLE, and Wi-Fi. This scheme allows wireless devices such as ZigBee, Thread and BLE devices to attempt reception while Wi-Fi is operating. If a valid packet is detected, reception continues; otherwise, reception stops. When wireless devices such as ZigBee, Thread and BLE finish receiving packets and request to transmit an acknowledgment frame, it is required to determine whether the current Wi-Fi is operating. If the current Wi-Fi is active, the acknowledgment frame transmission is canceled. The core of this scheme is to allow other wireless devices to perform reception during Wi-Fi operation, but it cannot solve the problem of multiple wireless devices being unable to work simultaneously due to contention for circuit resources. In addition, this scheme mainly addresses coexistence issues between a single wireless communication protocol and Wi-Fi and cannot solve coexistence problems among more wireless communication protocols.

### SUMMARY

Therefore, it is desired to provide a solution for allocating priorities to wireless communication modules with contention for circuit resources by a coexistence controller having a coexistence arbitration function, thereby providing a more efficient communication method compared to existing wireless communication coexistence solutions. The proposed solution aims to group the wireless communication modules and select priorities to ensure that at any given moment, at most one wireless communication module in the system performs the task of transmitting data packets, while, in other groups, only one wireless communication module attempts to receive data packets.

In a first aspect, a wireless communication method is disclosed, the method including: step 1: acquiring coexistence request priorities (Pti_Req) of a plurality of communication services of each of a plurality of wireless communication modules;
step 2: grouping, according to a circuit resource contention relationship, the plurality of wireless communication modules to obtain N groups, N being an integer greater than or equal to 2, and grouping the wireless communication modules having a circuit resource contention relationship into a same group;
step 3: sorting, for each of the N groups, the coexistence request priorities of the wireless communication modules in a current group to perform the following steps:
   step 3a: selecting a wireless communication module (Stotal) corresponding to a communication service having a highest coexistence request priority in the current group, and designating the coexistence request priority of this wireless communication module (Stotal) as the highest coexistence request priority (Pti_Reqmax);
   step 3b: selecting a wireless communication module (Srx) corresponding to the communication service having a highest coexistence request priority among wireless communication modules in a request-to-receive state in the current group;
step 4: sorting the highest coexistence request priorities (Pti_Reqmax) of the N groups, and designating the group with a maximum value of the highest coexistence request priority (Pti_Reqmax) as a priority group (Gtotal);
step 5: allocating a coexistence grant signal (Grant) to the wireless communication module (Stotal) having a highest intra-group transmission priority in the priority group (Gtotal); allocating, for each of remaining groups, a coexistence grant signal (Grant) to a wireless communication module (Srx) having a highest intra-group reception priority in the group.

In a second aspect, a wireless communication apparatus is disclosed, the apparatus including a circuitry configured to perform the following operations:
acquiring coexistence request priorities (Pti_Req) of a plurality of communication services of each of a plurality of wireless communication modules, wherein the plurality of wireless communication modules are divided into N groups according to a circuit resource contention relationship, wherein N is an integer greater than or equal to 2, and the wireless communication modules having a circuit resource contention relationship are grouped into a same group;
sorting, for each of the N groups, the coexistence request priorities of the wireless communication modules in the current group to perform a first arbitration of:
   selecting a wireless communication module (Stotal) corresponding to a communication service having a highest coexistence request priority in the current group, and designating the coexistence request priority of this wireless communication module (Stotal) as the highest coexistence request priority (Pti_Reqmax);
   selecting a wireless communication module (Srx) corresponding to a communication service having a highest coexistence request priority among wireless communication modules in a request-to-receive state in the current group;
sorting the highest coexistence request priorities (Pti_Reqmax) of the N groups to perform a second arbitration of:
   selecting and designating a group with a maximum value of the highest coexistence request priority (Pti_Reqmax) as a priority group (Gtotal);
allocating a coexistence grant signal (Grant) to the wireless communication module (Stotal) having a highest intra-group transmission priority in the priority group (Gtotal); allocating, for each of remaining groups, a coexistence grant signal (Grant) to a wireless communication module (Srx) having a highest intra-group reception priority in the group.

In a third aspect, a wireless communication system is disclosed, the system including:
a plurality of wireless communication modules, one or more antennas, and a coexistence controller;
wherein the coexistence controller is connected to each of the plurality of wireless communication modules via a coexistence bus;
wherein a plurality of communication services of each module of the plurality of wireless communication modules are allocated a coexistence request priority (Pti_Req) respectively;
the plurality of wireless communication modules are divided into N groups according to a circuit resource contention relationship, where N is an integer greater than or equal to 2, and the wireless communication modules having the circuit resource contention relationship are grouped into a same group;
the coexistence controller is configured to sort the coexistence request priorities of the wireless communication modules in the current group in each of the N groups, respectively, to perform a first arbitration of:
   selecting a wireless communication module (Stotal) corresponding to a communication service having a highest coexistence request priority in the current group, and designating the coexistence request priority of this wireless communication module (Stotal) as the highest coexistence request priority (Pti_Reqmax);
   selecting a wireless communication module (Srx) corresponding to a communication service having a highest coexistence request priority among wireless communication modules in a request-to-receive state in the current group;
the coexistence controller is configured to sort highest coexistence request priorities (Pti_Reqmax) of the N groups to perform a second arbitration of:
   selecting and designating a group with a maximum value of the highest coexistence request priority (Pti_Reqmax) as a priority group (Gtotal);
the coexistence controller is configured to allocate a coexistence grant signal (Grant) to the wireless communication module (Stotal) having a highest intra-group transmission priority in the priority group (Gtotal); allocate, for each of remaining groups, a coexistence grant signal (Grant) to a wireless communication module (Srx) having a highest intra-group reception priority in the group.

It is to be noted that in any appropriate case, any feature of any embodiment disclosed herein may be applied to any other embodiment. Likewise, any advantage of any embodiment may be applied to other embodiments, and vice versa. Other objects, features and advantages of the accompanying embodiments will be apparent from the following description.

Some embodiments are aimed at addressing, mitigating, alleviating, or eliminating at least some of the aforementioned or other disadvantages.

In particular, to address the above problem, the method for reducing wireless communication coexistence interference provided by the present disclosure allows, at any given moment, at most one wireless communication module to transmit, while permitting other multiple wireless communication modules that do not conflict in circuit resources to receive simultaneously. Furthermore, for multiple wireless communication modules that have conflicting circuit resources, the method disclosed herein allows the wireless communication module with the highest priority to exclusively occupy the circuit resources. Among them, circuit resources refer to hardware components such as baseband circuits, radio frequency circuits and antennas. The existence of conflicting circuit resources means that multiple wireless communication modules share a same circuit, and the circuit can only operate in one specific mode at a time. According to the disclosed method, effective communication in a terminal system with multiple wireless communication modules can be achieved, overcoming coexistence interference among different communication modules and improving the efficiency of multi-mode communication.

### BRIEF DESCRIPTION OF THE DRAWINGS

FIG. 1 illustrates a schematic structural diagram of a terminal system including a plurality of wireless communication modules.

FIG. 2 illustrates a schematic diagram showing connections between each wireless communication module and the coexistence control module.

FIG. 3 illustrates a schematic diagram showing signals transmitted between a coexistence bus (Coex Bus) and each wireless communication module.

FIG. 4 illustrates a schematic diagram showing arbitrations performed on wireless communication modules in a single group in the above steps 3a and 3b.

FIG. 5 illustrates a schematic diagram showing the arbitrations performed among N groups in the above steps 4 and 5.

FIG. 6 illustrates a block diagram of a terminal system including four wireless communication modules and a coexistence control module.

FIG. 7 illustrates a schematic diagram showing an example timing sequence of various coexistence signals in the terminal system according to FIG. 6.

### DETAILED DESCRIPTION OF THE PREFERRED EMBODIMENTS

The present disclosure will now be discussed with reference to several example embodiments. It should be understood that these embodiments are discussed only for the purpose of enabling those skilled in the art to better understand the present disclosure and thereby implement the present disclosure, rather than implying any limitation on the scope of the present disclosure.

It should be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting to example embodiments. As used herein, the singular forms “a”, “an” and “the” are intended to include the plural forms as well, unless the context clearly indicates otherwise. It will be further understood that when used herein, the terms “including”, “comprising”, “having”, “with”, “containing” and/or “incorporating” indicate the presence of stated features, elements and/or components, etc., but do not preclude the presence or addition of one or more other features, elements, components and/or combinations thereof.

In the following description and claims, unless defined otherwise, all technical and scientific terms used herein have the same meaning as commonly understood by one of ordinary skill in the art to which this disclosure belongs. Some exemplary embodiments of the present disclosure will be described below with reference to the accompanying drawings.

### Embodiment 1

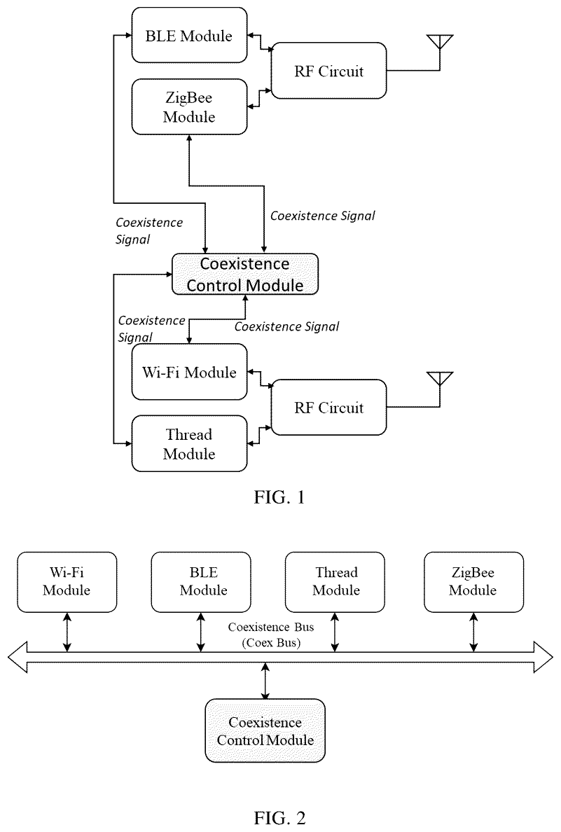

FIG. 1 is a schematic structural diagram of a terminal system including a plurality of wireless communication modules. The terminal system can implement a plurality of wireless communication functions through the plurality of wireless communication modules. As shown in FIG. 1, the terminal modules may include a BLE module, a ZigBee module, a Wi-Fi module and a Thread module. Among them, the BLE module and the ZigBee module share a radio frequency circuit and an antenna, so the two modules have a circuit resource contention relationship. The Wi-Fi module and the Thread module share a RF circuit and an antenna, so the two modules also have a circuit resource contention relationship. Among them, the radio frequency circuit and the antenna are configured to perform the tasks of receiving and transmitting data packets. The terminal system further includes a coexistence control module (Coex Controller), and each wireless communication module in the system is connected to the coexistence control module via a coexistence bus (Coex Bus). Specifically, FIG. 2 illustrates a schematic diagram showing a connection between each wireless communication module and the coexistence control module.

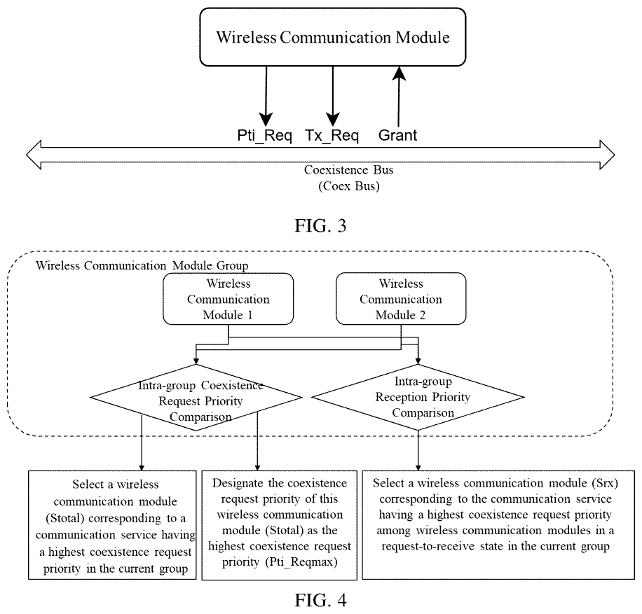

Furthermore, FIG. 3 illustrates a schematic diagram showing signals transmitted between a coexistence bus (Coex Bus) and each wireless communication module, including a coexistence request priority (Pti_Req), a request transmission signal (Tx_Req), and a coexistence grant signal (Grant). Among them, the coexistence request priority (Pti_Req) is a multi-bit width signal, which is configured to indicate a communication priority of each communication service corresponding to the wireless communication module; the request transmission signal (Tx_Req) is a single-bit width signal. When the request transmission signal (Tx_Req) is 1, it indicates that the corresponding wireless communication module is in a request-to-transmit state, and when the request transmission signal (Tx_Req) is 0, it indicates that the corresponding wireless communication module is in a request-to-receive state. The coexistence grant signal (Grant) is a single-bit width signal, indicating whether the coexistence control module allows the corresponding wireless communication module to perform communication. When the coexistence grant signal (Grant) is 1, it indicates that the coexistence control module allows the corresponding wireless communication module to operate according to the state indicated by the request transmission signal (Tx_Req).

As an example but not limitation, according to the communication characteristics and service scenarios of all wireless communication modules in the terminal system, a coexistence request priority (Pti_Req) is allocated to each wireless communication module in units of communication services. Specifically, firstly, the plurality of communication services of each wireless communication module are prioritized based on the following factors: a) the impact of transmission failure; b) the importance of the transmitted information; c) real-time requirements of the transmission service; d) a duration of channel or circuit resource occupation for transmission; and other possible factors. Under normal circumstances, a communication service with a high impact caused by transmission failure, high importance of information and a real-time requirement, and a low transmission duration will be given a higher priority.

Further, as an example but not limitation, a coexistence request priority (Pti_Req) may be determined according to the priority of the communication service of each communication module, and a specific coexistence request priority (Pti_Req) allocation strategy belongs to the scope of each communication protocol. For example, a method of allocating coexistence request priorities (Pti_Req) to each wireless communication module in units of communication services generally includes the following steps: a) counting all common communication services of all wireless communication modules in the terminal system; b) sorting priorities of these communication services according to factors such as tolerance to transmission failure and latency requirements of transmission; c) allocating different coexistence request priorities to the above communication services based on the sorting results.

Specifically, taking a multi-mode system including a Wi-Fi wireless communication module and a BLE wireless communication module as an example, the coexistence request priorities (Pti_Req) of a typical sequence in the system can be allocated as follows: a coexistence request priority of a timed wake-up (TWT) communication service of the Wi-Fi wireless communication module is 9, i.e., Wi-Fi TWT Pti_Req=9; a coexistence request priority of a connecting communication service of the BLE wireless communication module is 8, i.e., BLE Connecting Pti_Req=8; a coexistence request priority of a receiving beacon frame (RX Beacon) communication service of the Wi-Fi wireless communication module is 7, i.e., Wi-Fi RX Beacon Pti_Req=7; a coexistence request priority of a broadcast data packet (AUX_ADV) communication service of the BLE wireless communication module is 6, i.e., BLE AUX_ADV Pti_Req=6; a coexistence request priority of a transmit acknowledgment (TX ACK) communication service of the Wi-Fi wireless communication module is 5, i.e., Wi-Fi TX ACK Pti_Req=5. A larger value of the coexistence request priority (Pti_Req) indicates a higher communication priority.

According to a first aspect of the present disclosure, a wireless communication method is provided, the method includes following steps:

Step 1: acquiring coexistence request priorities (Pti_Req) of a plurality of communication services of each of a plurality of wireless communication modules.

Step 2: grouping, according to a circuit resource contention relationship, the plurality of wireless communication modules to obtain N groups, N being an integer greater than or equal to 2, and grouping the wireless communication modules having a circuit resource contention relationship into a same group. As an example but not limitation, when two or more wireless communication modules share a radio frequency circuit or an antenna, these wireless communication modules have a circuit resource contention relationship.

Step 3: sorting, for each of the N groups, the coexistence request priorities of the wireless communication modules in a current group to perform the following steps:
Step 3a: selecting a wireless communication module (Stotal) corresponding to a communication service having a highest coexistence request priority in the current group, and designate the coexistence request priority of this wireless communication module (Stotal) as the highest coexistence request priority (Pti_Reqmax).
Step 3b: selecting a wireless communication module (Srx) corresponding to the communication service having a highest coexistence request priority among wireless communication modules in a request-to-receive state in the current group.

Step 4: sorting the highest coexistence request priorities (Pti_Reqmax) of the N groups, and designate the group with a maximum value of the highest coexistence request priority (Pti_Reqmax) as a priority group (Gtotal).

Step 5: allocating a coexistence grant signal (Grant) to the wireless communication module (Stotal) having a highest intra-group transmission priority in the priority group (Gtotal); allocate, for each of remaining groups, a coexistence grant signal (Grant) to a wireless communication module (Srx) having a highest intra-group reception priority in the group. Preferably, allocating the coexistence grant signal to the wireless communication module in step 5 indicates that a current wireless communication module is authorized to perform transmission or reception according to a state indicated by the request transmission signal.

As an example but not limitation, FIG. 4 illustrates a schematic diagram showing arbitrations performed on wireless communication modules in a single group in the above steps 3a and 3b.

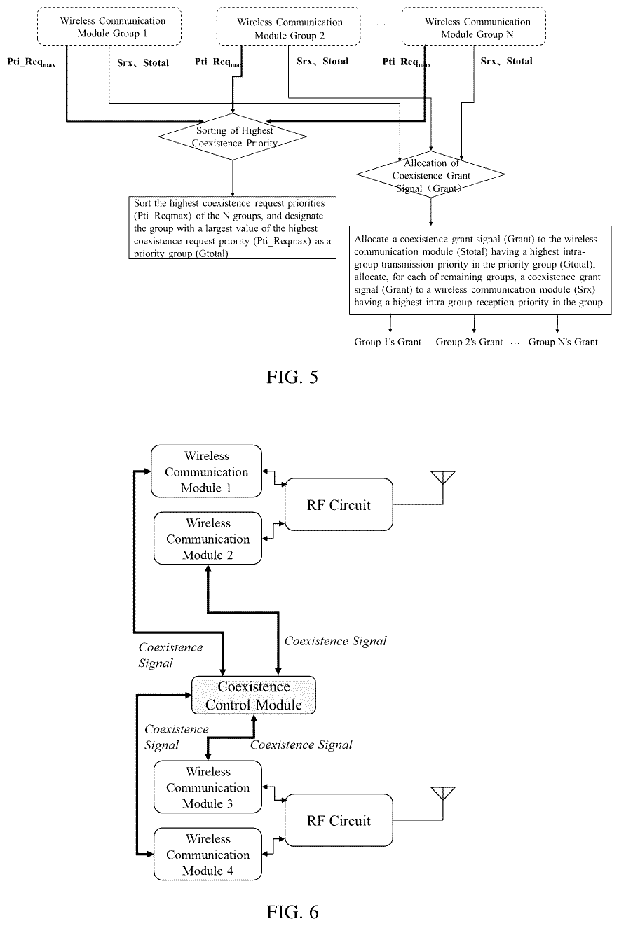

As an example but not limitation, FIG. 5 illustrates a schematic diagram showing the arbitrations performed among N groups in the above steps 4 and 5.

As an example but not limitation, the plurality of wireless communication modules may include at least two or more of a ZigBee module, a Bluetooth (BT) module, a Wi-Fi module, a Thread module, and a BLE module.

Preferably, before step 3, the wireless communication method further includes: receiving a request transmission signal (Tx_Req) sent by the wireless communication module, and the request transmission signal is a single-bit width signal; the current wireless communication module is indicated as in a request-to-transmit state in response to the request transmission signal being 1; the current wireless communication module is indicated as in a request-to-receive in response to the request transmission signal being 0.

Preferably, in step 3a, in response to at least two wireless communication modules in the current group including communication services having the highest coexistence request priority, the method further performs following steps:
determining current request transmission signals of the at least two wireless communication modules corresponding to the communication service having the highest coexistence request priority;
in response to that the current request transmission signal of one of the wireless communication modules is 1, the intra-group transmission priority of the wireless communication module is set to the highest (Stotal); in response to that the current request transmission signals of the at least two wireless communication modules are both 0, selecting one of the wireless communication modules according to a preset fixed priority, and setting the intra-group transmission priority of the wireless communication module as the highest (Stotal); and
designating the highest coexistence request priority in the group as Pti_Reqmax.

Preferably, in step 4, in response to at least two groups having a same maximum value of the highest intra-group coexistence request priority (Pti_Reqmax), the method further performs following steps:
determining current request transmission signals of the wireless communication modules in the at least two groups having the highest coexistence request priority in the group;
in response to the current request transmission signal of the wireless communication module of one of the groups being 1, set the coexistence priority of the group as the highest;
in response to the current request transmission signals of the wireless communication modules in the at least two groups both being 0, selecting one of the groups according to a preset fixed priority, and setting the coexistence priority of the group as the highest (Stotal).

### Embodiment 2

According to a second aspect of the present disclosure, a wireless communication apparatus is disclosed, the apparatus including a circuitry configured to perform the following operations:
acquiring coexistence request priorities (Pti_Req) of a plurality of communication services of each of a plurality of wireless communication modules, wherein the plurality of wireless communication modules are divided into N groups according to a circuit resource contention relationship, wherein N is an integer greater than or equal to 2, and the wireless communication modules having a circuit resource contention relationship are grouped into a same group;
sorting, for each of the N groups, the coexistence request priorities of the wireless communication modules in the current group to perform a first arbitration of:
   selecting a wireless communication module (Stotal) corresponding to a communication service having a highest coexistence request priority in the current group, and designating the coexistence request priority of this wireless communication module (Stotal) as the highest coexistence request priority (Pti_Reqmax);
   selecting a wireless communication module (Srx) corresponding to a communication service having a highest coexistence request priority among wireless communication modules in a request-to-receive state in the current group;
sorting the highest coexistence request priorities (Pti_Reqmax) of the N groups to perform a second arbitration of:
   selecting and designating a group with a maximum value of the highest coexistence request priority (Pti_Reqmax) as a priority group (Gtotal);
allocating a coexistence grant signal (Grant) to the wireless communication module (Stotal) having a highest intra-group transmission priority in the priority group (Gtotal); allocating, for each of remaining groups, a coexistence grant signal (Grant) to a wireless communication module (Srx) having a highest intra-group reception priority in the group. Preferably, allocating the coexistence grant signal to the wireless communication module indicates that a current wireless communication module is authorized to perform transmission or reception according to a state indicated by the request transmission signal.

As an example but not limitation, the plurality of wireless communication modules comprise at least two or more of a ZigBee module, a Bluetooth (BT) module, a Wi-Fi module, a Thread module, and a BLE module.

Preferably, the circuit of the wireless device is further configured to: before performing the first arbitration, receive a request transmission signal (Tx_Req) sent by the wireless communication module, wherein the request transmission signal is a single-bit width signal; the current wireless communication module is indicated as in a request-to-transmit state in response to the request transmission signal being 1; and the current wireless communication module is indicated as in a request-to-receive state in response to the request transmission signal being 0.

Preferably, in response to at least two wireless communication modules in the current group including communication services having the highest coexistence request priority, the method further performs following steps:
determining current request transmission signals of the at least two wireless communication modules corresponding to the communication service having the highest coexistence request priority;
in response to that the current request transmission signal of one of the wireless communication modules is 1, the intra-group transmission priority of the wireless communication module is set to the highest (Stotal); in response to that the current request transmission signals of the at least two wireless communication modules are both 0, selecting one of the wireless communication modules according to a preset fixed priority, and setting the intra-group transmission priority of the wireless communication module as the highest (Stotal); and
designating the highest coexistence request priority in the group as Pti_Reqmax.

Preferably, in response to at least two groups having a same maximum value of the highest intra-group coexistence request priority (Pti_Reqmax), the circuitry is further configured to perform following steps:
determining current request transmission signals of the wireless communication modules in the at least two groups having the highest coexistence request priority in the group;
in response to the current request transmission signal of the wireless communication module of one of the groups being 1, set the coexistence priority of the group as the highest;
in response to the current request transmission signals of the wireless communication modules in the at least two groups both being 0, selecting one of the groups according to a preset fixed priority, and setting the coexistence priority of the group as the highest (Stotal).

### Embodiment 3

According to a third aspect of the present disclosure, a wireless communication system is provided, the system comprising: a plurality of wireless communication modules, one or more antennas, and a coexistence controller. FIG. 6 illustrates a schematic diagram of a wireless communication system according to the third aspect of the present disclosure.

The coexistence controller is connected to each of the plurality of wireless communication modules via a coexistence bus.

A plurality of communication services of each module of the plurality of wireless communication modules are allocated coexistence request priorities (Pti_Req) respectively.

The plurality of wireless communication modules are divided into N groups according to a circuit resource contention relationship, where N is an integer greater than or equal to 2, and the wireless communication modules having the circuit resource contention relationship are grouped into a same group.

The coexistence controller is configured to sort the coexistence request priorities of the wireless communication modules in the current group in each of the N groups, respectively, to perform a first arbitration of:
selecting a wireless communication module (Stotal) corresponding to a communication service having a highest coexistence request priority in the current group, and designating the coexistence request priority of this wireless communication module (Stotal) as the highest coexistence request priority (Pti_Reqmax);
selecting a wireless communication module (Srx) corresponding to a communication service having a highest coexistence request priority among wireless communication modules in a request-to-receive state in the current group;
the coexistence controller is configured to sort a highest coexistence request priorities (Pti_Reqmax) of the N groups to perform a second arbitration of:
   selecting and designating a group with a maximum value of the highest coexistence request priority (Pti_Reqmax) as a priority group (Gtotal);
the coexistence controller is configured to allocate a coexistence grant signal (Grant) to the wireless communication module (Stotal) having a highest intra-group transmission priority in the priority group (Gtotal); allocate, for each of remaining groups, a coexistence grant signal (Grant) to a wireless communication module (Srx) having a highest intra-group reception priority in the group.

### Example 1

A wireless communication system includes: a plurality of wireless communication modules, one or more antennas, and a coexistence controller. The coexistence controller is connected to the plurality of wireless communication modules via a coexistence bus (Coex Bus), and the coexistence controller provides a coexistence arbitration function. The specific functions of the coexistence controller include the following:

### 1) Grouping a Plurality of Wireless Communication Modules

The coexistence controller groups all wireless communication modules, and places those wireless communication modules with competition for hardware circuit resources (such as RF circuits, baseband signal processing circuits, etc.) into a same group. Since there is contention for circuit resources among the communication modules in the same group, only one wireless communication module in the same group is allowed to operate at any given moment.

The specific way of grouping can be configured according to the actual hardware sharing relationship of the plurality of wireless communication modules connected to the coexistence controller.

It is worth noting that the concept of “grouping” in the present disclosure is limited to the sharing of hardware circuit resources, such as wireless communication modules using the same antenna and/or radio frequency, baseband circuits, etc., and whether the spectrum and wireless medium are shared is not a consideration for grouping in this disclosure. Specifically, if a terminal system includes a 2.4 GHz Wi-Fi communication module and a 2.4 GHz BT communication module, but these two modules do not share circuit resources, they will not be grouped into a same group. This design can ensure that only one wireless communication module in the same group operates at any given moment, thereby solving the competition for circuit resources in the terminal system with the plurality of wireless communication modules. This design also allows the highest-priority module with reception needs in other non-conflicting groups to attempt receiving information while the group with the highest coexistence priority is transmitting/receiving information, thereby improving communication efficiency.

### 2) Sorting Coexistence Request Priorities Within Each Group to Perform a First Arbitration

The coexistence controller compares and sorts the coexistence request priorities of the wireless communication modules in each group based on the grouping of the wireless communication modules to perform a first arbitration. The purpose of the first arbitration is to select a wireless communication module (Stotal) corresponding to a communication service having a highest coexistence request priority in the current group, and designate the coexistence request priority of this wireless communication module (Stotal) as the highest coexistence request priority (Pti_Reqmax). Specifically, the coexistence request priorities (Pti_Req) of all wireless communication modules requesting transmission within the current group are compared, and the highest coexistence request priority (Pti_Req) is selected and designated as Pti_Reqmax, with the corresponding wireless communication module is designated as Stotal. It is worth noting that for the wireless communication modules in the terminal system, the state may be a request-to-transmit state. If not in a request-to-transmit state, it defaults to a request-to-receive state.

The purpose of the coexistence controller performing the first arbitration further includes selecting a wireless communication module (Srx) corresponding to a communication service having a highest coexistence request priority among wireless communication modules in a request-to-receive state in the current group. The coexistence controller selects a wireless communication module (Srx) with the highest coexistence request priority (Pti_Req) from all wireless communication modules in the request reception state (ie, wireless communication modules with Tx_Req being 0) in the current group.

When performing the above-mentioned first arbitration, if two wireless communication modules have the equal coexistence request priorities (Pti_Req), the following two scenarios are considered:

(a) If one of the two wireless communication modules has a coexistence grant signal (Grant) of 1, indicating that this module currently occupies the hardware circuit resources, thus its coexistence request priority is set higher. For example, at time t1, the BLE wireless communication module obtains the highest coexistence request priority and thus operates; at time t2, the coexistence request priority of the ZigBee wireless communication module is increased compared to time t1 and becomes equal to that of the BLE wireless communication module. Since the coexistence request priority of the BLE wireless communication module is higher at time t1, the coexistence grant signal (Grant) of the BLE wireless communication module is 1 before the judgment at time t2. Therefore, as described in (a), at time t2, the coexistence request priorities of the BLE wireless communication module and the ZigBee wireless communication module are equal, but in this judgment, the BLE wireless communication module is still considered to have a higher priority.

(b) If the current coexistence grant signals (Grant) of the two wireless communication modules are both 0, a priority comparison may be performed for the two devices with equal coexistence request priorities (Pti_Req) by presetting a fixed priority, for example, the priority of the wireless communication module with a smaller sequence number in the group is set to be higher.

### 3) Sorting Coexistence Request Priorities Among Groups to Perform a Second Arbitration

After the above-mentioned first arbitration, each wireless communication module group generates a set of the highest intra-group transmission priority (Stotal), the highest intra-group reception priority (the coexistence request priority corresponding to the wireless communication module Srx), and the highest coexistence request priority (Pti_Reqmax) in the group.

The coexistence controller further compares the highest coexistence request priorities (Pti_Reqmax) of all groups, selects and designates the group with the highest priority as a priority group (Gtotal).

If the highest coexistence request priorities (Pti_Reqmax) of the two groups are equal, the processing method is similar to that in 2) above, specifically:

(a) If one of the two groups includes a wireless communication module whose current coexistence grant signal (Grant) is 1, indicating that this module currently occupies the hardware circuit resources, thus the coexistence request priority of the group to which it belongs is set to be higher.

(b) If the current coexistence grant signals (Grant) of the wireless communication modules of the two groups are both 0, a priority comparison may be performed for the two groups with equal coexistence request priorities (Pti_Req) by presetting a fixed priority.

### 4) Generating a Coexistence Grant Signal

For the priority group (Gtotal) with the highest coexistence priority selected in 3), the wireless communication module (Stotal) with the highest intra-group transmission priority in the group is allocated a coexistence grant signal (Grant). For other groups, the coexistence grant signal (Grant) is allocated to the wireless communication module (Srx) with the highest intra-group reception priority in each group.

It is worth noting that the location of the coexistence controller or coexistence control module described in the present disclosure is not limited and can be set in any chip or module in the terminal system.

According to the method disclosed herein, it is possible to allow only the wireless communication modules in the group with the highest coexistence request priority to transmit, ensuring that at most only one device in the entire terminal system can perform a transmission operation, thereby guaranteeing that the operation of the highest priority communication protocol or module in the entire system is not disturbed. In contrast, for other groups with lower priorities, the wireless communication module with the highest priority in the group and in the request-to-receive state is allowed to perform the receiving operation, thereby improving the efficiency of multi-mode communication.

### Example 2

FIG. 6 illustrates a block diagram of a terminal system including four wireless communication modules and a coexistence control module. The coexistence control module is connected to the four wireless communication modules respectively through a coexistence bus. A wireless communication module 1 and a wireless communication module 2 share a radio frequency circuit and an antenna, and thus have a contention for hardware circuit resources, so they are grouped into a group, namely, group 1. A wireless communication module 3 and a wireless communication module 4 share a radio frequency circuit and an antenna, and thus have a contention for hardware circuit resources, so they are grouped into another group, namely, group 2.

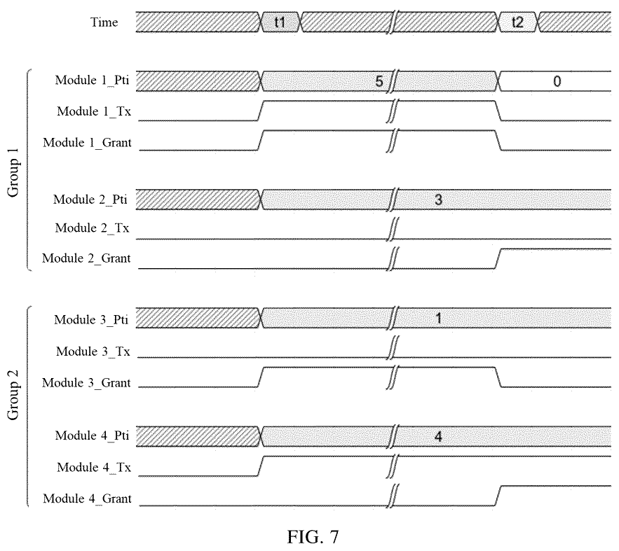

FIG. 7 illustrates a schematic diagram showing an example timing sequence of various coexistence signals in the terminal system according to FIG. 6.

At time t1, in the group 1, the coexistence request priority (Pti_Req) of the wireless communication module 1 is 5, and the coexistence request priority (Pti_Req) of the wireless communication module 2 is 3. Therefore, the coexistence control module determines that the wireless communication module with the highest intra-group transmission priority (Stotal) in the group 1 at time t1 is the wireless communication module 1, and the highest coexistence request priority (Pti_Reqmax) in the group 1 is 5. In addition, the request transmission signal (Tx_Req) of the wireless communication module 2 is 0, indicating that the wireless communication module 2 is in the request-to-receive state. Therefore, the wireless communication module (Srx) with the highest intra-group reception priority in the group 1 is the wireless communication module 2.

Similarly, at time t1, in the group 2, the coexistence request priority (Pti_Req) of the wireless communication module 3 is 1, and the coexistence request priority (Pti_Req) of the wireless communication module 4 is 4. Therefore, the coexistence control module determines that the wireless communication module with the highest intra-group transmission priority (Stotal) in the group 2 at time t1 is the wireless communication module 4, and the highest coexistence request priority (Pti_Reqmax) in the group 2 is 4. In addition, the request transmission signal (Tx_Req) of the wireless communication module 3 is 0, indicating that the wireless communication module 3 is in the request-to-receive state. Therefore, the wireless communication module (Srx) with the highest intra-group reception priority in the group 2 is the wireless communication module 3.

Furthermore, since the highest coexistence request priority (Pti_Reqmax) in the group 1 is 5 and the highest coexistence request priority (Pti_Reqmax) in the group 2 is 4, the wireless communication module (Stotal) with the highest intra-group transmission priority in the group 1 at time t1, i.e., the wireless communication module 1, is allocated a coexistence grant signal (Grant), that is, the coexistence grant signal (Grant) of the wireless communication module 1 is 1, allowing it to transmit data. The wireless communication module (Srx) with the highest intra-group receiving priority in the group 2, namely, the wireless communication module 3, is allocated a coexistence grant signal (Grant), that is, the coexistence grant signal (Grant) of the wireless communication module 3 is 1, allowing it to receive data. The coexistence grant signals (Grant) of the remaining wireless communication modules are 0.

At time t2, the coexistence request priority (Pti_Req) of the wireless communication module 1 in the group 1 changes to 0 due to the switching of the communication services, such as the end of a Wi-Fi TX ACK. At this time, the coexistence request priority (Pti_Req) of the wireless communication module 2 in the group 1 is still 3, therefore, the coexistence control module determines that the wireless communication module with the highest intra-group transmission priority (Stotal) in the group 1 at time t2 is the wireless communication module 2, and the highest coexistence request priority (Pti_Reqmax) in the group 1 is 3. In addition, the request transmission signals (Tx_Req) of wireless communication module 1 and wireless communication module 2 are both 0, indicating that both are in the request-to-receive state. Therefore, the wireless communication module (Srx) with the highest intra-group reception priority in the group 1 is also the wireless communication module 2.

Since the highest coexistence request priority (Pti_Reqmax) in the group 1 is 3 and the highest coexistence request priority (Pti_Reqmax) in the group 2 is 4, the wireless communication module (Stotal) with the highest intra-group transmission priority in the group 2 at time t2, i.e., the wireless communication module 4, is allocated a coexistence grant signal (Grant), that is, the coexistence grant signal (Grant) of the wireless communication module 4 is 1, allowing it to transmit data. The wireless communication module (Srx) with the highest intra-group receiving priority in the group 1, namely, the wireless communication module 2, is allocated a coexistence grant signal (Grant), that is, the coexistence grant signal (Grant) of the wireless communication module 2 is 1, allowing it to receive data. The coexistence grant signals (Grant) of the remaining wireless communication modules are 0.

### Embodiment 4

According to a fourth aspect of the present disclosure, it is provided a product including one or more tangible computer-readable non-transitory storage medium, wherein the one or more tangible computer-readable non-transitory storage medium includes computer-executable instructions which, when executed by at least one computer processor, cause the at least one computer processor to implement the wireless communication method as described above.

### Embodiment 5

According to a fifth aspect of the present disclosure, a wireless communication device is provided, comprising: a plurality of wireless communication modules; one or more antennas; a memory; a processor; and a coexistence controller, the coexistence controller being connected to each of the plurality of wireless communication modules via a coexistence bus, and the coexistence controller being configured to execute the wireless communication method as described above.

According to the present disclosure, wireless communication modules with a circuit resource contention relationship in a multi-mode terminal system are grouped into the same group, and priority sorting in the group is used to ensure that only one device operates at any given moment in the same group, thereby resolving the competition for circuit resources in the multi-mode communication. Additionally, only one wireless communication module in the group with the highest coexistence request priority is allowed to perform a transmission operation, thereby ensuring that the operation of the communication module with the highest priority in the entire system is not disturbed. Meanwhile, for other groups with lower priorities, the module with the highest priority in each group that is in the request-to-receive state is allowed to perform the reception operation, thereby effectively improving the efficiency of the multi-mode communication.

It is to be understood that the naming of modules and the selection of interacting modules within the present disclosure are for illustrative purposes only and that nodes suitable for performing any of the methods described above may be configured in a variety of alternative ways to be able to perform the suggested process actions.

It should also be noted that the units described in this disclosure are to be regarded as logical entities and not necessarily as separate physical entities.

Certain aspects of the inventive concept have mainly been described above with reference to a few embodiments. However, as is readily appreciated by the person skilled in the art, embodiments other than the ones disclosed above are equally possible and within the scope of the inventive concept. Similarly, while many different combinations have been discussed, not all possible combinations are disclosed. Those skilled in the art will appreciate that other combinations exist and are within the scope of the inventive concept. Furthermore, as will be appreciated by the skilled person, the embodiments disclosed herein are equally applicable to other standards and communication systems, and any feature from a particular figure disclosed in conjunction with other features may be applicable to any other figure and/or combined with different features.

1. A wireless communication method, comprising:
step 1: acquiring coexistence request priorities (Pti_Req) of a plurality of communication services of each of a plurality of wireless communication modules;
step 2: grouping, according to a circuit resource contention relationship, the plurality of wireless communication modules to obtain N groups, N being an integer greater than or equal to 2, and grouping the wireless communication modules having a circuit resource contention relationship into a same group;
step 3: sorting, for each of the N groups, the coexistence request priorities of the wireless communication modules in a current group to perform following steps:
step 3a: selecting a wireless communication module (Stotal) corresponding to a communication service having a highest coexistence request priority in the current group, and designating the coexistence request priority of this wireless communication module (Stotal) as the highest coexistence request priority (Pti_Reqmax);
step 3b: selecting a wireless communication module (Srx) corresponding to the communication service having a highest coexistence request priority among wireless communication modules in a request-to-receive state in the current group;
step 4: sorting the highest coexistence request priorities (Pti_Reqmax) of the N groups, and designating the group with a maximum value of the highest coexistence request priority (Pti_Reqmax) as a priority group (Gtotal);
step 5: allocating a coexistence grant signal (Grant) to the wireless communication module (Stotal) having a highest intra-group transmission priority in the priority group (Gtotal); allocating, for each of remaining groups, a coexistence grant signal (Grant) to a wireless communication module (Srx) having a highest intra-group reception priority in the group.

2. The method according to claim 1, wherein before step 3, the wireless communication method further comprises:
receiving a request transmission signal (Tx_Req) sent by the wireless communication module, wherein the request transmission signal is a single-bit width signal; the current wireless communication module is indicated as in a request-to-transmit state in response to the request transmission signal being 1; and the current wireless communication module is indicated as in a request-to-receive in response to the request transmission signal being 0.

3. The method according to claim 2, wherein
allocating the coexistence grant signal to the wireless communication module in step 5 indicates that a current wireless communication module is authorized to perform transmission or reception according to a state indicated by the request transmission signal.

4. The method according to claim 1, wherein
in step 3a, in response to at least two wireless communication modules in the current group including communication services having the highest coexistence request priority, the method further performs following steps:
determining current request transmission signals of the at least two wireless communication modules corresponding to the communication service having the highest coexistence request priority;
in response to the current request transmission signal of one of the wireless communication modules being 1, setting an intra-group transmission priority of the wireless communication module as the highest (Stotal);
in response to the current request transmission signals of the at least two wireless communication modules both being 0, selecting one of the wireless communication modules according to a preset fixed priority, and setting the intra-group transmission priority of the wireless communication module as the highest (Stotal); and
designating the highest coexistence request priority in the group as Pti_Reqmax.

5. The method according to claim 1, wherein
in step 4, in response to at least two groups having a same maximum value of the highest intra-group coexistence request priority (Pti_Reqmax), the method further performs following steps:
determining current request transmission signals of the wireless communication modules in the at least two groups having the highest coexistence request priority in the group;
in response to the current request transmission signal of the wireless communication module of one of the groups being 1, setting the coexistence priority of the group as the highest;
in response to the current request transmission signals of the wireless communication modules in the at least two groups both being 0, selecting one of the groups according to a preset fixed priority, and setting the coexistence priority of the group as the highest (Stotal).

6. The method according to claim 1, wherein
the plurality of wireless communication modules comprise at least two or more of a ZigBee module, a Bluetooth (BT) module, a Wi-Fi module, a Thread module, and a BLE module.

7. A wireless communication device, comprising a circuit configured to perform following operations:
acquiring coexistence request priorities (Pti_Req) of a plurality of communication services of each of a plurality of wireless communication modules, wherein the plurality of wireless communication modules are divided into N groups according to a circuit resource contention relationship, wherein N is an integer greater than or equal to 2, and the wireless communication modules having a circuit resource contention relationship are grouped into a same group;
sorting, for each of the N groups, the coexistence request priorities of the wireless communication modules in the current group to perform a first arbitration of:
selecting a wireless communication module (Stotal) corresponding to a communication service having a highest coexistence request priority in the current group, and designating the coexistence request priority of this wireless communication module (Stotal) as the highest coexistence request priority (Pti_Reqmax);
selecting a wireless communication module (Srx) corresponding to a communication service having a highest coexistence request priority among wireless communication modules in a request-to-receive state in the current group;
sorting the highest coexistence request priorities (Pti_Reqmax) of the N groups to perform a second arbitration of:
selecting and designating a group with a maximum value of the highest coexistence request priority (Pti_Reqmax) as a priority group (Gtotal);
allocating a coexistence grant signal (Grant) to the wireless communication module (Stotal) having a highest intra-group transmission priority in the priority group (Gtotal); allocating, for each of remaining groups, a coexistence grant signal (Grant) to a wireless communication module (Srx) having a highest intra-group reception priority in the group.

8. The wireless communication device according to claim 7, wherein
the circuit of the wireless device is further configured to: before performing the first arbitration, receive a request transmission signal (Tx_Req) sent by the wireless communication module, wherein the request transmission signal is a single-bit width signal; the current wireless communication module is indicated as in a request-to-transmit state in response to the request transmission signal being 1; and the current wireless communication module is indicated as in a request-to-receive state in response to the request transmission signal being 0.

9. The wireless communication device according to claim 7, wherein
allocating the coexistence grant signal to the wireless communication module in step 5 indicates that a current wireless communication module is authorized to perform transmission or reception according to a state indicated by the request transmission signal.

10. The wireless communication device according to claim 7, wherein
in response to that there are at least two wireless communication modules corresponding to the communication service having the highest coexistence request priority in the current group, the device is further configured to perform following steps of:
determining current request transmission signals of the at least two wireless communication modules corresponding to the communication service having the highest coexistence request priority;
in response to the current request transmission signal of one of the wireless communication modules being 1, setting an intra-group transmission priority of the wireless communication module as the highest (Stotal);
in response to the current request transmission signals of the at least two wireless communication modules both being 0, selecting one of the wireless communication modules according to a preset fixed priority, and setting the intra-group transmission priority of the wireless communication module as the highest (Stotal); and
designating the highest coexistence request priority in the group as Pti_Reqmax.

11. The wireless communication device according to claim 7, wherein
in response to at least two groups having a same maximum value of the highest intra-group coexistence request priority (Pti_Reqmax), the device is further configured to perform following steps of:
determining current request transmission signals of the wireless communication modules in the at least two groups having the highest coexistence request priority in the group;
in response to the current request transmission signal of the wireless communication module of one of the groups being 1, setting the coexistence priority of the group as the highest;
in response the current request transmission signals of the wireless communication modules in the at least two groups both being 0, selecting one of the groups according to a preset fixed priority, and setting the coexistence priority of the group as the highest (Stotal).

12. The wireless communication device according to claim 7, wherein
the plurality of wireless communication modules comprise at least two or more of a ZigBee module, a Bluetooth (BT) module, a Wi-Fi module, a Thread module, and a BLE module.

13. A wireless communication system, comprising:
a plurality of wireless communication modules, one or more antennas, and a coexistence controller;
wherein the coexistence controller is connected to each of the plurality of wireless communication modules via a coexistence bus;
wherein a plurality of communication services of each module of the plurality of wireless communication modules are allocated coexistence request priorities (Pti_Req) respectively;
the plurality of wireless communication modules are divided into N groups according to a circuit resource contention relationship, where N is an integer greater than or equal to 2, and the wireless communication modules having the circuit resource contention relationship are grouped into a same group;
the coexistence controller is configured to sort the coexistence request priorities of the wireless communication modules in the current group in each of the N groups, respectively, to perform a first arbitration of:
selecting a wireless communication module (Stotal) corresponding to a communication service having a highest coexistence request priority in the current group, and designating the coexistence request priority of this wireless communication module (Stotal) as the highest coexistence request priority (Pti_Reqmax);
selecting a wireless communication module (Srx) corresponding to a communication service having a highest coexistence request priority among wireless communication modules in a request-to-receive state in the current group;
the coexistence controller is configured to sort highest coexistence request priorities (Pti_Reqmax) of the N groups to perform a second arbitration of
selecting and designating a group with a maximum value of the highest coexistence request priority (Pti_Reqmax) as a priority group (Gtotal);
the coexistence controller is configured to allocate a coexistence grant signal (Grant) to the wireless communication module (Stotal) having a highest intra-group transmission priority in the priority group (Gtotal); allocate, for each of remaining groups, a coexistence grant signal (Grant) to a wireless communication module (Srx) having a highest intra-group reception priority in the group.

14. The wireless communication system according to claim 13, wherein
the coexistence controller is configured to: before performing the first arbitration, receive a request transmission signal (Tx_Req) sent by the wireless communication module, wherein the request transmission signal is a single-bit width signal; the current wireless communication module is indicated as in a request-to-transmit state in response to the request transmission signal being 1; and the current wireless communication module is indicated as in a request-to-receive state in response to the request transmission signal being 0.

15. The wireless communication system according to claim 13, wherein
allocating the coexistence grant signal to the wireless communication module indicates that a current wireless communication module is authorized to perform transmission or reception according to a state indicated by the request transmission signal.

16. The wireless communication system according to claim 13, wherein
in response to that there are at least two wireless communication modules corresponding to the communication service having the highest coexistence request priority in the current group, the device is further configured to perform following steps of:
determining current request transmission signals of the at least two wireless communication modules corresponding to the communication service having the highest coexistence request priority;
in response to the current request transmission signal of one of the wireless communication modules being 1, setting an intra-group transmission priority of the wireless communication module as the highest (Stotal);
in response to the current request transmission signals of the at least two wireless communication modules both being 0, selecting one of the wireless communication modules according to a preset fixed priority, and setting the intra-group transmission priority of the wireless communication module as the highest (Stotal); and
designating the highest coexistence request priority in the group as Pti_Reqmax.

17. The wireless communication system according to claim 13, wherein
in response to at least two groups having a same maximum value of the highest intra-group coexistence request priority (Pti_Reqmax), the system is further configured to perform following steps of:
determining current request transmission signals of the wireless communication modules in the at least two groups having the highest coexistence request priority in the group;
in response to the current request transmission signal of the wireless communication module of one of the groups being 1, setting the coexistence priority of the group as the highest;
in response the current request transmission signals of the wireless communication modules in the at least two groups both being 0, selecting one of the groups according to a preset fixed priority, and setting the coexistence priority of the group as the highest (Stotal).

18. The wireless communication system according to claim 13, wherein
the plurality of wireless communication modules comprise at least two or more of a ZigBee module, a Bluetooth (BT) module, a Wi-Fi module, a Thread module, and a BLE module.

19. (canceled)

20. (canceled)
